(19) United States
(12) Patent Application Publication
(10) Pub. No.: US 2002/0178520 A1
(43) Pub. Date: Dec. 5, 2002

(54) Portable centrifugal car washer

(76) Inventors: Kyung-Dong Kim, Gunpo-shi (KR); Gil-Hee Lee, Incheon-shi (KR); Tae-Hong Shin, Sungnam-shi (KR)

Correspondence Address: HARNESS, DICKEY & PIERCE, P.L.C., P.O. BOX 828, BLOOMFIELD HILLS, MI, 48303, US

(21) Appl. No.: 10/131,590

(22) Filed: Apr. 24, 2002

(30) Foreign Application Priority Data
Apr. 25, 2001 (KR) 2001-22498

(51) Int. Cl. B60S 3/06

(52) U.S. Cl. 15/24; 15/97.1; 15/97.3; 15/50.3; 15/52

(57) ABSTRACT

Disclosed is a portable centrifugal car washer comprising a storeroom, disposed in a case, for storing car washing liquid, a pump for pumping out the car washing liquid in the storeroom; and a centrifugal unit for rotating the car washing liquid at a high speed, resolving into moisture particles and then spraying the moisture particles on a surface of a car. The car washer performs the washing, drying and polishing operation at the same time and thus remarkably reducing an operation time. Further, the portable centrifugal car washer of the present invention has a small size so that an operator facilely uses, and the car washing liquid can be stored in the car washer. Therefore, the car washer can be facilely carried and kept and also used anywhere at any time. Furthermore, the portable centrifugal car washer of the present invention resolves a small quantity of water into a moisture particle state by centrifugal force and then sprays the moisture particles on a body surface of a car to carry out a car washing operation, thereby reducing the consumption of water for the car washing operation and also minimizing,generation of waste water due to the car washing operation.

### BACKGROUND OF THE INVENTION

1. Field of the Invention

The present invention relates to a portable centrifugal car washer, and more particularly to a portable centrifugal car washer which minimizes generation of waste water and also can be used anywhere at any time.

2. Description of the Related Art

In a typical car washing method, water is sprayed on the body of the car to wash dust and other foreign substances. However, since such car washing method generally requires a great deal of water and thus, generates a large quantity of waste water, there is a problem that the car washing can be performed in only a specific place. Further, in order to remove and dry the water from the body of the car after the car washing, a separate operation has to be carried out. Therefore, there is another problem that it takes so much time.

### SUMMARY OF THE INVENTION

It is an object of the present invention to provide a portable centrifugal car washer which has a small size to be capable of being facilely carried and kept and which resolves a small quantity of water into a moisture particle state by centrifugal force and then sprays the moisture particles on a body surface of a car to carry out a car washing operation, thereby reducing the consumption of water for the car washing operation and also minimizing generation of waste water due to the car washing operation.

It is another object of the present invention to provide a portable centrifugal car washer which is capable of carrying out removing of dust on the body surface of the car, washing and drying at the same time, thereby remarkably reducing an operation time.

This invention provides a portable centrifugal car washer, comprising a storeroom, disposed in a case, for storing car washing liquid, a pump for pumping out the car washing liquid in the storeroom; and a centrifugal unit for rotating the car washing liquid at a high speed, resolving into moisture particles and then spraying the moisture particles on a surface of a car.

According to another aspect of the present invention, there is provided a portable centrifugal car washer comprising a streamline case, a storing tank for storing car washing liquid, a pump for pumping out the car washing liquid stored in the storing tank, and a centrifugal unit for rotating the car washing liquid at a high speed, resolving into moisture particles and then spraying the moisture particles on a surface of a car, wherein the storing tank is formed into a handle and exposed to an upper side of the case.

### BRIEF DESCRIPTION OF THE DRAWINGS

The foregoing and other objects, features, and advantages of the invention will be apparent from the following, more particular, description of the preferred embodiments of the invention, as illustrated in the accompanying drawings in which,

FIG. 1 is a perspective view showing an embodiment of a portable centrifugal car washer according to the present invention;

FIG. 2 is a cross-sectional view showing a construction of the portable centrifugal car washer of FIG. 1;

FIG. 3 is a bottom view showing the construction of the portable centrifugal car washer of FIG. 1;

FIG. 4 is an exploded perspective view showing a construction of a centrifugal spaying unit of the portable centrifugal car washer of FIG. 1;

FIG. 5 is a perspective view showing another embodiment of the portable centrifugal car washer according to the present invention;

FIG. 6 is a cross-sectional view showing a construction of the portable centrifugal car washer of FIG. 5;

FIG. 7 is a plan view of the portable centrifugal car washer of FIG. 5;

FIG. 8 is a bottom view of the portable centrifugal car washer of FIG. 5; and

FIG. 9 is a schematic view showing an operation status of the portable centrifugal car washer of FIG. 5.

### DETAILED DESCRIPTION OF THE INVENTION

Now, preferred embodiments of the present will be described in detail with reference to the annexed drawings.

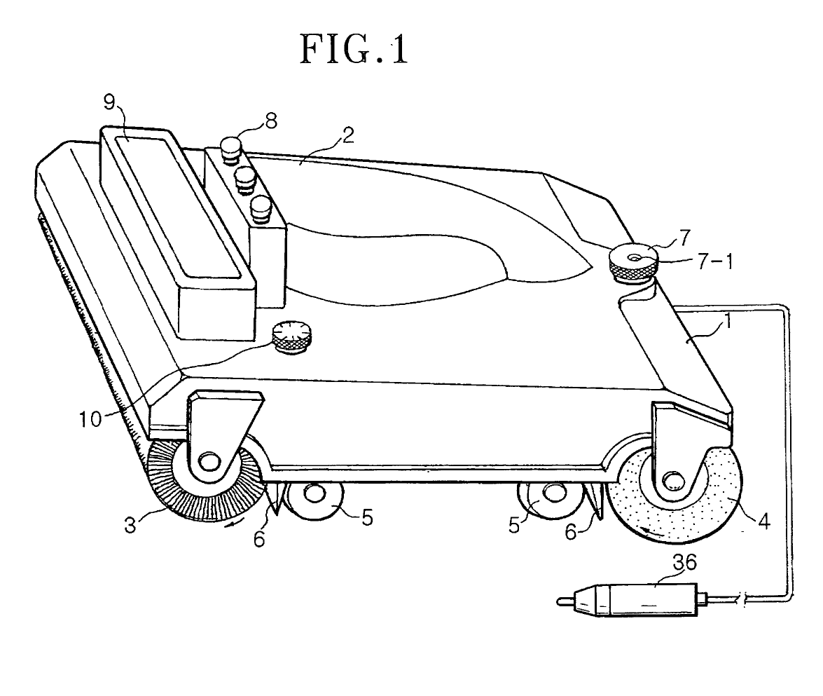

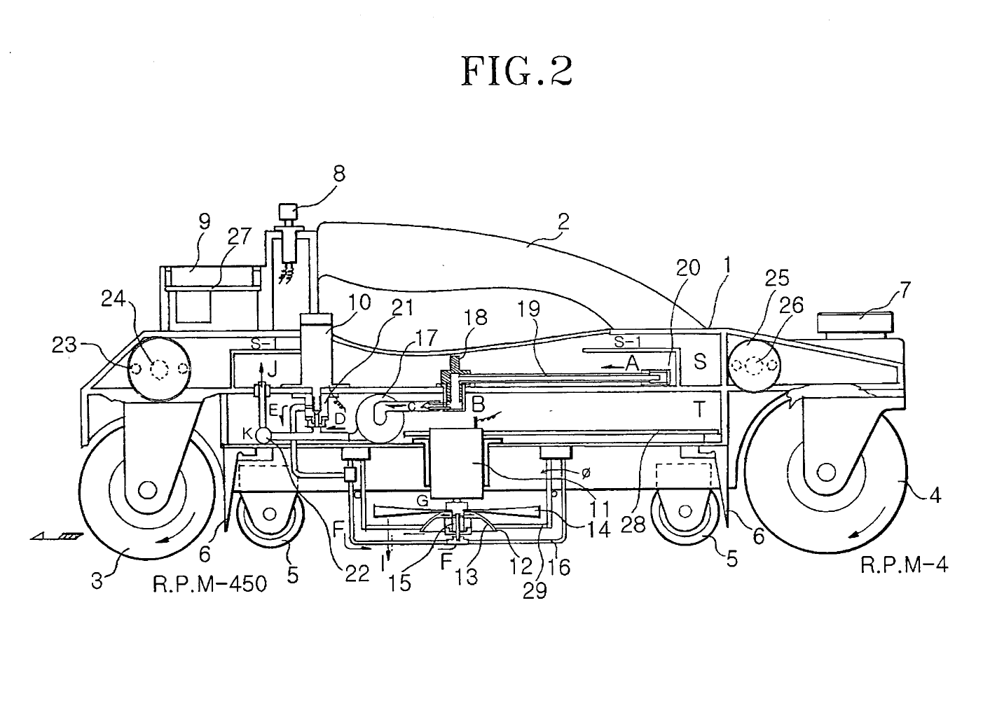

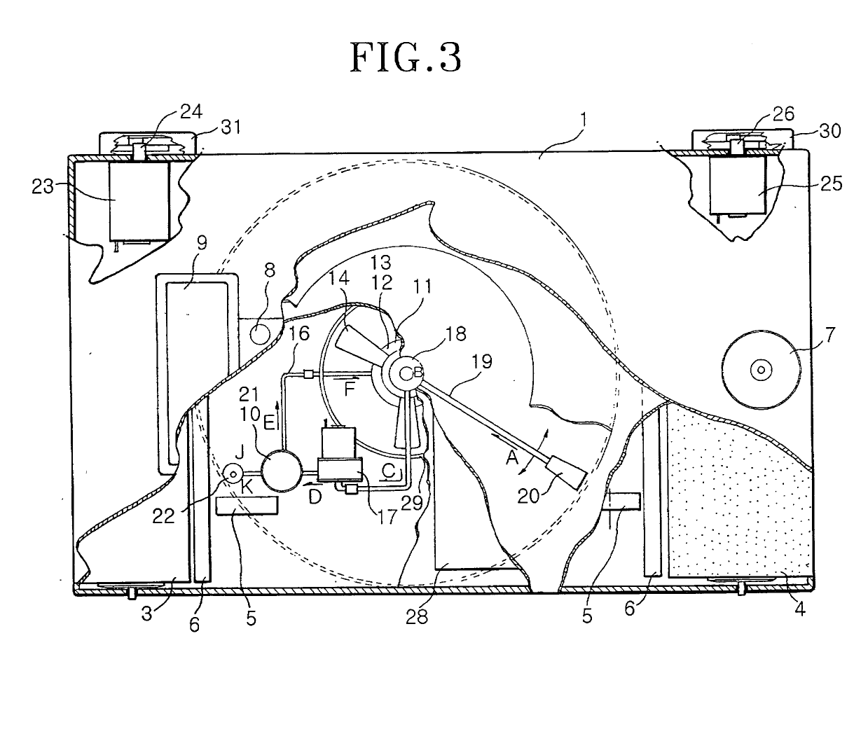

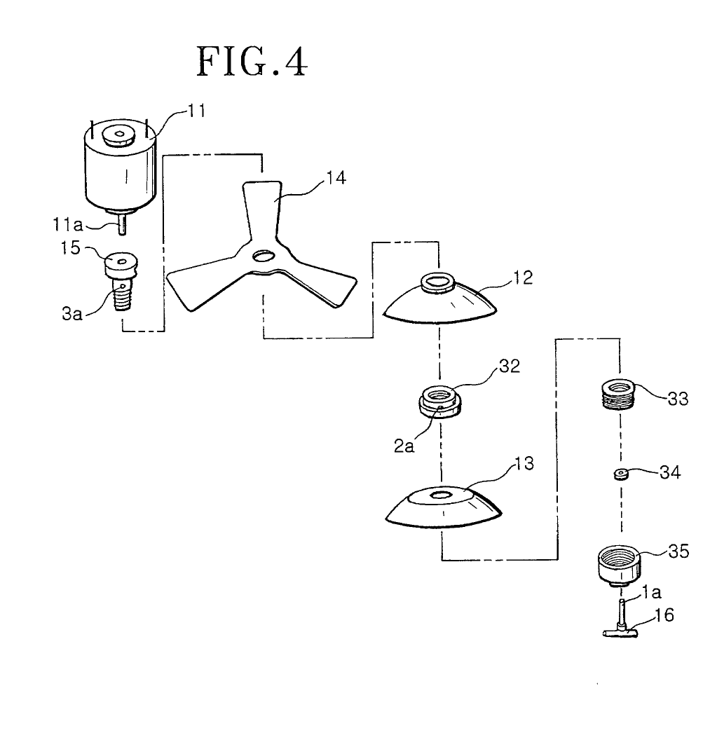

FIG. 1 is a perspective view showing an embodiment of a portable centrifugal car washer according to the present invention, FIG. 2 is a cross-sectional view showing a construction of the portable centrifugal car washer of FIG. 1, FIG. 3 is a bottom view showing the construction of the portable centrifugal car washer of FIG. 1, and FIG. 4 is an exploded perspective view showing a construction of a centrifugal spaying unit of the portable centrifugal car washer of FIG. 1.

As shown in drawings, a portable centrifugal car washer has a rectangular case 1, and a handle 2 is formed at an upper center portion of the case 1. At a side of the handle 1, there is formed at lease one or more driving switch 8 for operating the car washer of the present invention. An LCD or LED displaying unit 9 for displaying an operation status is disposed at a side of the driving switch 8.

It is preferable that the driving switch 8 and the LCD or LED displaying unit 9 are positioned at a front portion of the handle 2, and more preferably, the driving switch 8 is disposed between the handle 2 and the LCD or LED displaying unit 9.

An inner portion of the case 1 is divided into an upper layer, an intermediate layer and a lower layer. In the upper layer, there is disposed a store room S for storing mixed liquid (hereinafter, called “car washing liquid”) of washing liquid and water.

In the intermediate layer, there are disposed an electronic circuit board 28 for controlling an operation of each unit in the car washer, a driving motor 23 and 25 electrically connected to the electronic circuit board 28, a water pump 17 for pumping out the car washing liquid from the store room S, a water amount regulator 10 for regulating a supplying amount of the car washing liquid and a water pressure regulating valve 22 for withdrawing the residual car washing liquid after the car washing operation.

In the lower layer, there are disposed a front roller 3 for removing dust on the surface of the car at the early stage of the car washing operation and a rear roller 4 for washing and draying the foreign substances and water on the surface of the car at the final stage of the car washing operation and simultaneously polishing the surface of the car. Preferably, the rear roller 4 is formed of non-woven fabric. Reduction gearboxes 30 and 31 are disposed at front and rear ends of the lower layer. A reduction gear 24, 26 is provided in each gearbox 30, 31 and connected to a driving motor 23, 25. Below the driving motor 23, 25, i.e., at front and rear sides of a bottom portion of the, case 1, there are rotatably disposed the front and rear rollers 3 and 4 which are interlocked with the reduction gears 24 and 26 to be rotated about their own rotational shaft.

In addition, a centrifugal unit Φ for rotating the car washing liquid at a high speed to resolve the car washing liquid into a moisture particle state is provided in the lower layer. The centrifugal unit Φ includes a fan 14, a fan motor 11 for driving the fan 14, and a plurality of conical plates 12 and 13 which are connected to a shaft 11a of the fan motor 11 to generate the centrifugal force by the high-speed rotation of the fan motor 11. The conical plates 12 and 13 are in the form of a dish in which a hole is punched at a center portion thereof. At an outer side of the centrifugal unit Φ, there is provided a safety net 29 for preventing approach and contact. The conical plates 12 and 13 are stacked with each other. A distributor 32 in which the car washing liquid is introduced through a water supplying pipe 16 is provided between the conical plates 12 and 13. In an outer circumferential surface of the distributor 21, there are formed a plurality of ejection holes 2a for ejecting the supplied car washing liquid on a surface of the conical plates 12 and 13.

A reference numeral 5 in the drawing designates a wheel, and 6 is a blocking plate for blocking sprayed car washing liquid.

Further, a reference numeral 15 is a rotational shaft of the centrifugal unit Φ, 33 is a nut for connecting the fan 14 and the conical plate 12, 13, and 34 is a packing for preventing a water leakage, and 35 is a fixing cover for fixing the packing.

According to the portable centrifugal car washer of the present invention, first, the car washing liquid is injected through an injection hole 7 formed on an upper rear portion of the case 1 at a preparing stage. The car washing liquid is stored in the storeroom S for a while. Since the surface of the car is in the form of a streamline, the stored car washing liquid is supplied to an inner portion, i.e., a front side of a wing portion S-1 by a using angle of the car washer on the surface of the car. The car washing liquid moved to the front side is continuously supplied to the centrifugal unit Φ.

When switching on the driving switch, each unit mounted in the case 1 is operated. At this time, if the car washer is moved forward, the front roller 3 is rolled to remove the dust and foreign substances attached on the surface of the car, while being closely contacted with the surface of the car.

Then, the car washing liquid moved to the inner portion of the wing portion S-1 is pumped by the water pump 17 is transferred through the water supplying pipe 16 to an inner portion of the centrifugal unit Φ. In this process, the car washing liquid is passed through a filter 20 to remove impurities, and then arrived through, in turn, a sucking pipe 19, the pump 17 and a liquid supplying regulation valve 21 at the centrifugal unit Φ.

The flow of the car washing liquid from the storeroom S to the centrifugal unit Φ is shown with arrows A, B, C, D, E, F and G in FIGS. 1 and 2.

The car washing liquid moved to the centrifugal unit Φ is supplied through a nozzle 1a of the water supplying pipe 16 to the inside of the rotational shaft 11a of the centrifugal unit Φ, and then distributed through a through hole 3a formed in the rotational shaft 11a and the ejection hole 2a of the distributor 32 to the surface of the conical plates 12 and 13 due to the centrifugal force generated by the rotation of the rotational shaft 11a. At this time, the car washing liquid distributed on the surface of the conical plates 12 and 13 is resolved in the moisture particles by the centrifugal force. The resolved car washing liquid is spread in an outer direction H of the conical plates 12 and 13, and then sprayed on the surface of the car by wind force of the fan 14. At this time, the moisture particles of the spayed car washing liquid forms a thin water film (not shown) on the surface of the car. This water film is infiltrated into a fine portion of the dust and other foreign substances to maximize cohesive action and thus separate the dust and other foreign substances from the surface of the car. As described above, after the washing operation using the car washing liquid is finished, the rear roller 4 formed of non-woven fabric washes and dries completely the residual foreign substances and water, thereby completing the car washing operation, while being rotated at a lower speed. Meanwhile, after the car washing operation is completed, the water pressure regulating valve 22 withdraws the residual car washing liquid remained in the centrifugal unit Φ in a reverse direction J and returns the residual car washing liquid to the storeroom S.

In the portable centrifugal car washer of the present invention, water amount of about 300 ml is sufficient to wash one car. When using aqueous wax for the car washing operation, it is possible to wash the car only with about 50 ml of the water. Further, since the car washer of the present invention carries out the washing and drying operation of the car at the same time, while moving forward, the polishing operation can be also performed at the same time, when using the aqueous wax.

A rotational speed of the front roller 3 is in an extent of 150 rpm to 350 rpm, preferably, 260 rpm. It is preferable that a rotational speed of the conical plates 12 and 13 and the fan 14 is maintained in about 20,000 rpm. Further, a rotational speed of the rear roller 4 is maintained in an extent of 150 rpm to 350 rpm, preferably, 220 rpm.

The portable centrifugal car washer of the present invention as described above may have an intelligent microcomputer to select a washing course according to a contaminated status of the car. The microcomputer realizes an level control and also may carry out an alarm function in a visual or aural method in case of lack of water. Further, a pulse generator for analyzing a movement speed of the car washer may be provided to precisely control the amount of the car washing liquid spayed on the surface of the car

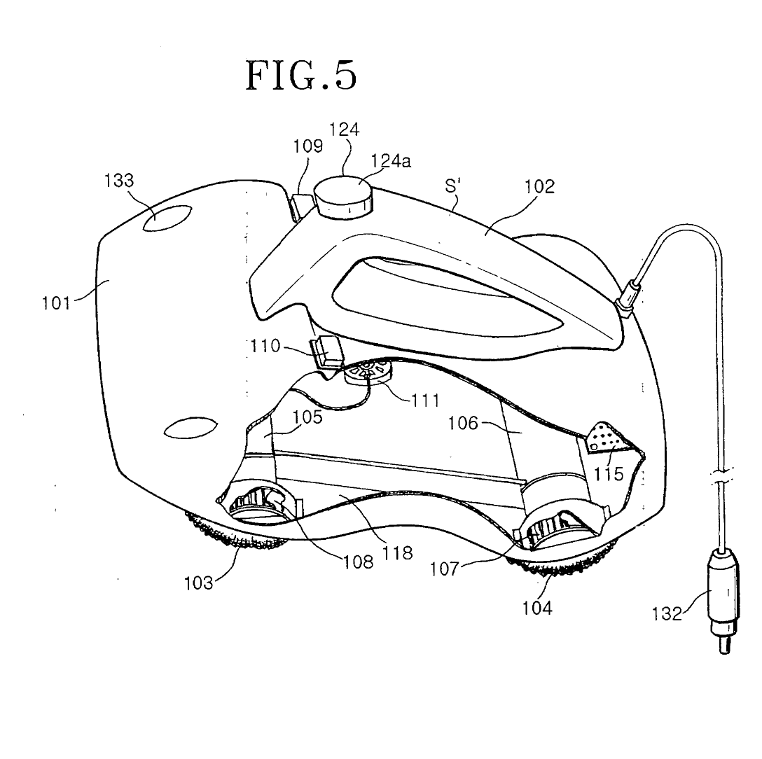

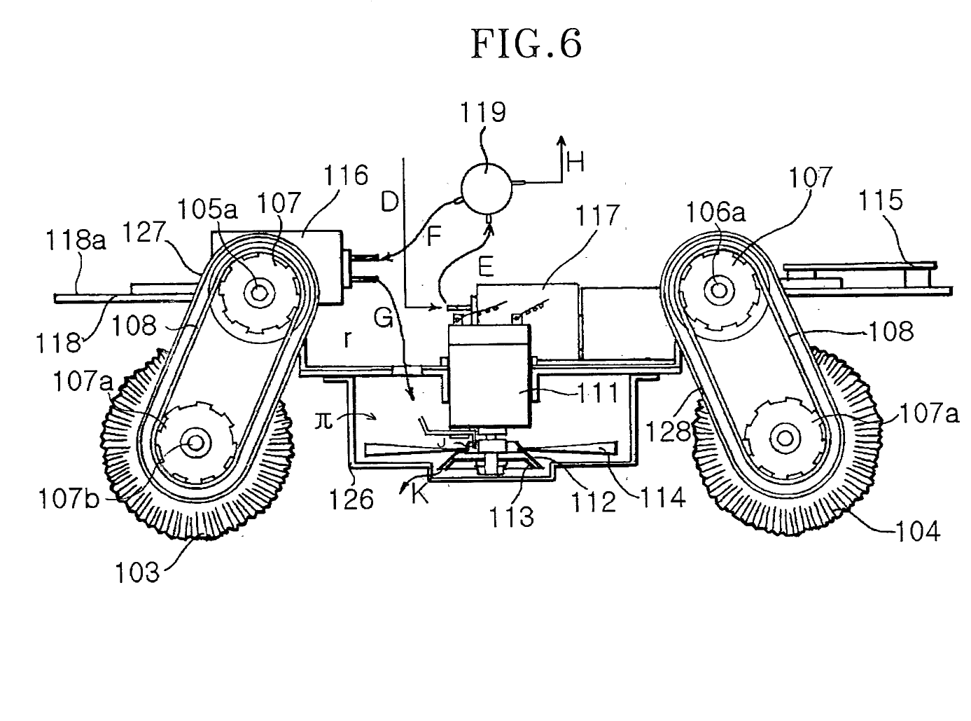

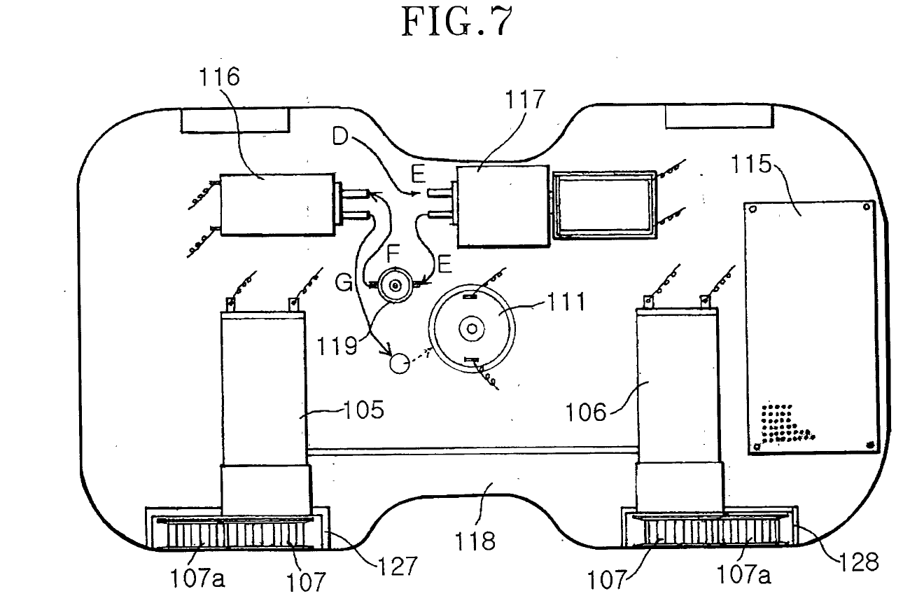

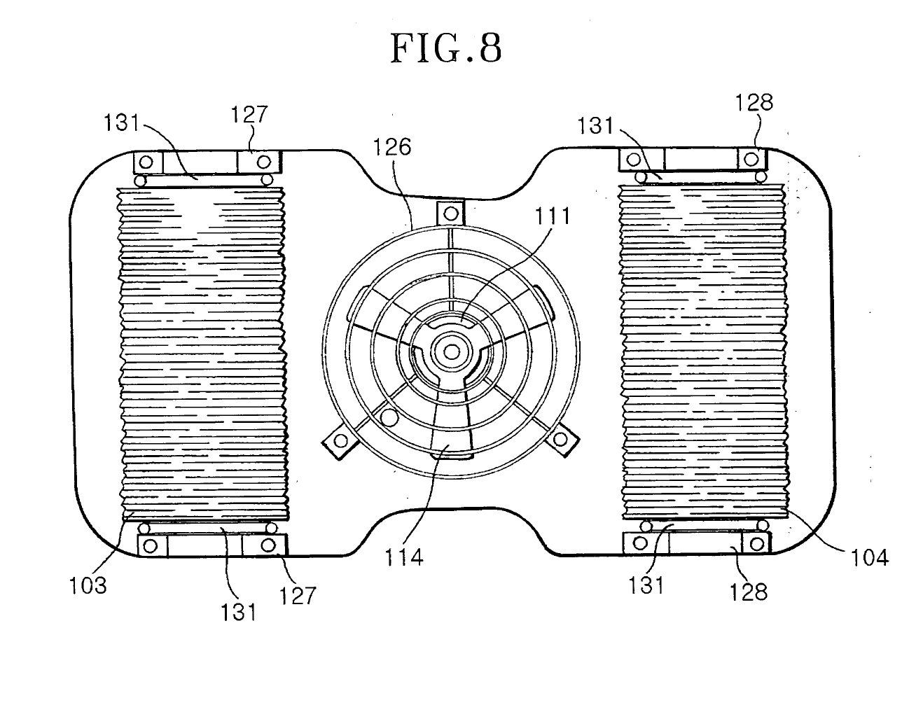

FIG. 5 is a perspective view showing another embodiment of the portable centrifugal car washer according to the present invention, FIG. 6 is a cross-sectional view showing a construction of the portable centrifugal car washer of FIG. 5, FIG. 7 is a plan view of the portable centrifugal car washer of FIG. 5 and FIG. 8 is a bottom view of the portable centrifugal car washer of FIG. 5.

As shown in drawings, a portable centrifugal car washer according to another embodiment of the present invention has a streamline case 100 in the form of a car. A handle 102 is formed at an upper center portion of the case 100. The handle 102 has a hollow structure and thus functions as a storing tank S′ for storing car washing liquid mixed with car washing liquid and water. At an upper end of a side of the handle, there is formed a liquid supplying port 124 for supplying the car washing liquid to the storing tank S′. The liquid supplying portion 124 is opened/closed using a stopper 124a.

In addition, at both sides of the handle 102, there are provided a power switch 109 for supplying power to each unit in the car washer and a pump controlling switch 110 for controlling a pumping speed of a pump 117 and a flow rate of the car washing liquid from the storing tank S′. The pump controlling switch 110 may be a toggle switch or a multi-step switch. At a front portion of the case 100, there is provided at least one or more lamp portion 133 for displaying an on/off state of the car washer of the present invention. At a rear portion thereof is provided a power connector 132 for supplying the power to the car washer. As shown in FIG. 5, the power connector 132 may be formed into a cable structure for directly connecting to power source, or an internal charging structure in which a desired discharging unit (not shown) is mounted in the case.

A frame 118 for supporting each unit is provided in the case 100. The frame 118 has a concave portion r recessed downward with respect to a length direction of the frame 118. The liquid supplying pump 117 for pumping the car washing liquid from the storing tank S′ is disposed on the concave portion. At a side of an upper layer 118a of the frame 118, there is provided a distributor 119 for distributing the car washing liquid pumped from the storing tank S′, and at a side of the distributor 119 is provided a liquid supplying regulation valve 116 for controlling the flow or the flow rate of the car washing liquid. At other side of the upper layer 118a of the frame 118, there is provided a circuit board 115 for controlling each unit according to an operation of the power switch 109 and the pump controlling switch 110. Driving motors 105 and 106 are mounted on the frame 118 so as to be electrically connected to the circuit board 115.

Legs 127 and 128 for supporting the frame 118 are respectively disposed at both sides of the front and rear portion of the frame 118. The legs 127 and 128 are extended downward to be symmetric with respect to the frame 118. A driving gear 107 coupled to a driving shaft 105a, 106a of each driving motor 105, 106 is provided in an upper end of each leg 127, 128. In a lower end of the each leg 127, 128, there is provided a driven gear 107a interlocked with the driving gear 107. The driving gear 107 and the driven gear 107a are connected through a timing belt 108 to be interlocked with each other. Between the driven gears 107a opposite to each other with the frame 118 in the center, there is disposed a rotational shaft 107b onto which a roller 103, 104 is inserted. Preferably, the roller is classified into a front roller 103 disposed at a front portion of the frame 118 to remove dust and other foreign substances on a surface of a car and a rear roller 104 disposed at a rear portion of the frame 118 to dry water on the surface of the car and also polish the surface of the car. The front roller 103 is preferably formed of wool fabric, and the wool fabric may be combined with polyester or nylon. Further, the rear roller 104 is formed of moisture absorption and dry fabric, preferably, microfiber. The microfiber is a well-known material comprised of polyamide and polyester.

Meanwhile, the driven gear 107a is coupled to an end of the rotational shaft 107b.

At a lower layer of the frame 118, there is provided a centrifugal unit π for resolving the car washing liquid into moisture particles. The centrifugal unit π includes a motor 111 disposed through a center portion of the concave portion r of the frame 118 to be protruded to an upper surface of the concave portion r, a conical plate 112, 113 connected to the motor 111, a fan 114 and a safety net 126 for protecting the members. The conical plate 112, 113 is to apply centrifugal force to the car washing liquid supplied from the pump 117 and thus resolve the car washing liquid into the moisture particles. It is preferable that an upper conical plate 112 and a lower conical plate 113 are detachably stacked with each other.

Meanwhile, the distributor 119 disposed in the concave portion r of the frame 118 also functions to return the car washing liquid remained in the centrifugal unit π to the storing tank S′ after the car washing operation.

Hereinafter, an operation of the portable centrifugal car washer of the present invention will be described fully.

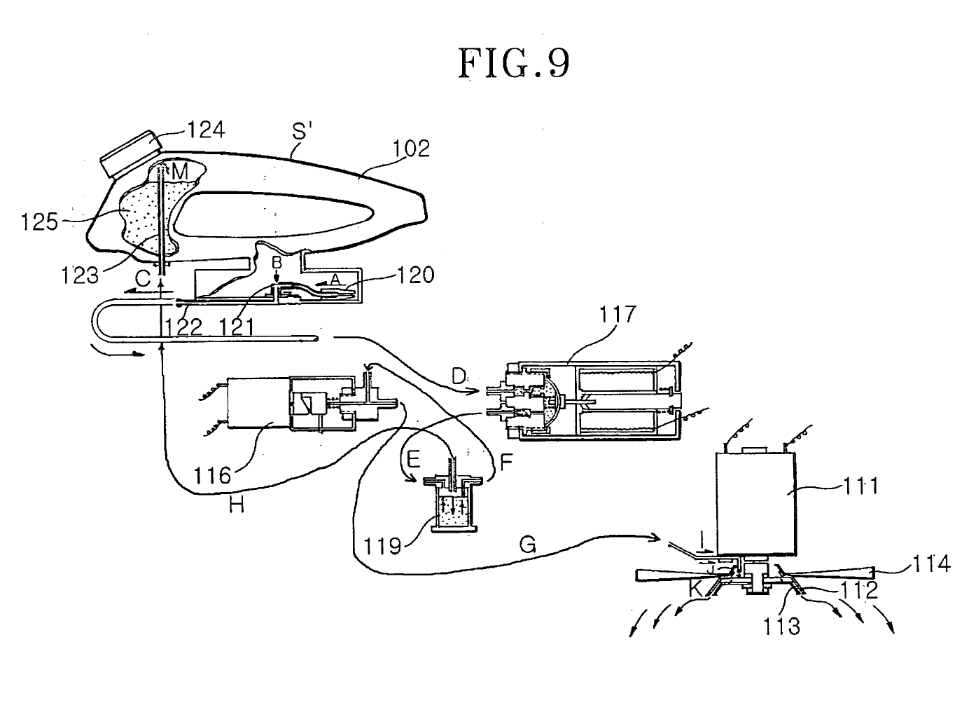

FIG. 9 is a schematic view showing an operation status of the portable centrifugal car washer of FIG. 5. As shown in drawings, first, the car washing liquid is injected through the liquid supplying port 124 in the storing tank S′. The liquid supplying port 124 is closed by the stopper 124a after the car washing liquid is filled in the storing tank S′. Then, when switching on the power switch 109 and the pump controlling switch 110, the lamp 133 formed on the front portion of the case 100 is turned on to indicate that the car washer is under operation. At the same time, the driving motors 105 and 106 are operated. Thus, the driven gear 107 interlocked with driving gear 107 is rotated. The rotational force of the driven gear 107a is transferred through the rotational shaft 107b to the front and rear roller 103 and 104. In this situation, if the car washer is moved forward on the surface of the car, the front roller 103 removes the dust and foreign substances attached on the surface of the car, while being closely contacted with the surface of the car.

While the front and rear roller 103 and 104 are rotated, the upper and lower conical plates 112 and 113 and the fan 114 in the centrifugal unit π are rotated by the motor 111. At this time, the car washing liquid 125 is pumped out from the storing tank S′ by the pump 117, and then transferred through the distributor 119 and the liquid supplying regulation valve 116 to the centrifugal unit π so as to be resolved into the moisture particles by the high speed rotation of the conical plates 112 and 113.

The flow of the car washing liquid from the storing tank S′ to the centrifugal unit π is shown with arrows A, B, C, D, E, F and G in FIGS. 6, 7 and 9.

The car washing liquid 125, which is resolved by the centrifugal unit π, is sprayed on the surface of the car by the fan 114 disposed at an upper side of the upper and lower conical plates 112 and 113 to form a water film (not shown) on the surface of the car. This water film is infiltrated into a fine portion of the dust and other foreign substances to maximize cohesive action and thus separate the dust and other foreign substances from the surface of the car. At this time, the rear roller 104 washes and dries completely the residual foreign substances and water. Meanwhile, in case aqueous wax is injected into the storing tank S′, the polishing operation can be also performed along with the washing and drying operation by the rear roller 104. In addition, after the car washing operation is completed, the distributor 119 withdraws the residual car washing liquid remained in the centrifugal unit π and returns the residual car washing liquid to the storing tank S′.

In the car washer of the present invention, a rotational speed of the front roller 103 is in an extent of 150 rpm to 350 rpm, preferably, 260 rpm. It is preferable that a rotational speed of the conical plates 112 and 113 and the fan 114 is maintained in about 15,000 rpm. Further, a rotational speed of the rear roller 104 is maintained in an extent of 150 rpm to 350rpm, preferably, 220 rpm.

Although not shown in drawings, the portable centrifugal car washer of the present invention as described above may have an intelligent microcomputer for selecting a washing course according to a contaminated status of the car and a pulse generator for analyzing a movement speed of the car washer, thereby precisely controlling the amount of the car washing liquid spayed on the surface of the car

As described above, the portable centrifugal car washer according to the present invention includes the front roller for removing the dust and other foreign substances attached on the surface of the car, the centrifugal unit for resolving the car washing liquid into the moisture particles, spaying the resolved car washing liquid on the surface of the car and thus separating the dust and other foreign substances from the surface of the car, and the rear roller formed of the non-woven fabric to wash the residual foreign substances and carry out the polishing operation at the same time, thereby performing the washing, drying and polishing operation at the same time and thus remarkably reducing an operation time.

Further, the portable centrifugal car washer of the present invention has a small size so that an operator facilely uses, and the car washing liquid can be stored in the car washer. Therefore, the car washer can be facilely carried and kept and also used anywhere at any time.

Furthermore, the portable centrifugal car washer of the present invention resolves a small quantity of water into a moisture particle state by centrifugal force and then sprays the moisture particles on a body surface of a car to carry out a car washing operation, thereby reducing the consumption of water for the car washing operation and also minimizing generation of waste water due to the car washing operation.

Although the invention has been particularly shown and described with reference to a preferred embodiment thereof, it will be understood by those skilled in the art that changes and modification in detail may be made therein without departing from the spirit and scope of the invention.

The disclosure of Republic of Korea application Serial No. 2001-22498 filed Apr. 25, 2001 is hereby incorporated by reference.

1. A portable centrifugal car washer, comprising:
a storeroom, disposed in a case, for storing car washing liquid;
a pump for pumping out the car washing liquid in the storeroom; and
a centrifugal unit for rotating the car washing liquid at a high speed, resolving into moisture particles and then spraying the moisture particles on a surface of a car.

2. The washer in accordance with claim 1, wherein the centrifugal unit includes a fan, a fan motor for driving the fan and a plurality of conical plates connected to a shaft of the fan motor to be rotated at a high speed.

3. The washer in accordance with claim 1 or 2, further comprising a distributor interposed between the conical plates so that the car washing liquid moved through a liquid supplying pipe is introduced in the distributor, wherein the distributor has a plurality of ejection holes for distributing the car washing liquid to the surface of the conical plates in an outer circumferential surface thereof.

4. The washer in accordance with claim 1, wherein the case is provided with a plurality of driving motors, a front roller for removing dust on the surface of the car, and a rear roller for washing residual foreign substances and drying residual car washing liquid spayed on the surface of the car, and the front and rear rollers are interlocked with the driving motors.

5. The washer in accordance with claim 1 or 4, further comprising a water pressure regulating valve for returning the residual car washing liquid to the storeroom after an car washing operation.

6. The washer in accordance with claim 4, wherein the rear roller is formed of non-woven fabric.

7. The washer in accordance with claim 1, further comprising a handle formed on an upper portion of the case.

8. The washer in accordance with claim 1, further comprising an LCD or LED display unit, disposed at a side of the handle, for displaying an operation status.

9. A portable centrifugal car washer, comprising:
a streamline case;
a storing tank for storing car washing liquid;
a pump for pumping out the car washing liquid stored in the storing tank; and
a centrifugal unit for rotating the car washing liquid at a high speed, resolving into moisture particles and then spraying the moisture particles on a surface of a car,
wherein the storing tank is formed into a handle and exposed to an upper side of the case.

10. The washer in accordance with claim 9, further comprising a frame, disposed in the case, for supporting internal units, a plurality of legs disposed at both lower sides of the frame to be extended downward, and a plurality of gears rotatably disposed in the leg.

11. The washer in accordance with claim 10, wherein the gears in each leg is connected by a timing belt to be interlocked with each other.

12. The washer in accordance with claim 9 or 10, further comprising a liquid supplying regulation valve, disposed on an upper surface of the frame, for controlling flow rate of the car washing liquid, a concave portion formed at a side of the frame to be recessed downward, and a plurality of driving motors disposed on the frame.

13. The washer in accordance with claim 10, further comprising rotational shafts disposed between the corresponding gears opposite to each other with the frame in the center, a front roller, inserted onto the rotational shaft disposed at a front side of the frame, for remove dust on a surface of a car, and a rear roller, inserted onto the rotational shaft disposed at a front side of the frame, for washing residual foreign substances.

14. The washer in accordance with claim 13, wherein the front roller is formed of wool fabric.

15. The washer in accordance with claim 13, wherein the rear roller is formed of moisture absorption and dry microfiber.

16. The washer in accordance with claim 9 or 10, further comprising a distributor, disposed on the frame, for supplying the car washing liquid to the centrifugal unit when washing the car, and returning residual car washing liquid to the restoring tank after an car washing operation.

17. The washer in accordance with claim 9 or 10, wherein the centrifugal unit disposed at a bottom surface includes a motor disposed through a center portion of the concave portion of the frame to be protruded to an upper surface of the concave portion, a fan connected to a shaft of the motor, a plurality of conical plates rotated at a high speed by the motor to provide centrifugal force to the car washing liquid, and a safety net, disposed around the centrifugal unit, for preventing approach and contact.
